(19) United States
(12) Patent Application Publication
(10) Pub. No.: US 2005/0172863 A1
(43) Pub. Date: Aug. 11, 2005

(54) Concrete admixture and use in low temperatures

(76) Inventor: Lawrence J. Terzo, Elk Grove Village, IL (US)

Correspondence Address: Alice O. Martin;Barnes & Thornburg, P.O. Box 2786, Chicago, IL, 60690-2786, US

(21) Appl. No.: 10/774,302

(22) Filed: Feb. 6, 2004

(51) Int. Cl. C04B 14/00

(52) U.S. Cl. 106/724; 106/819; 106/823; 106/785; 106/705; 106/708; 106/709

(57) ABSTRACT

A novel admixture including an accelerator and a corrosion inhibitor, that accelerates the time required to set a concrete mixture at low temperature even in concrete containing a pozzolan such as fly ash. A suitable accelerator includes a mixture of a non-chloride type accelerator and a nitrite-based corrosion inhibitor.

### BACKGROUND OF THE DISCLOSURE

Chemical accelerators are used by the ready-mixed concrete and precast industry. For example, non-chloride type accelerators decrease the setting time of a concrete mixture. This, in turn, enables the concrete mixture to reach a desired strength in a shorter amount of time, thereby decreasing labor costs of the job and allowing concrete to be used in applications where a limited amount of time is available.

A common practice in the concrete industry is to mix inexpensive materials such as films into concrete mixtures to lower the overall cost of the mixture. One such cost reducing material is a pozzolan such as fly ash, silica, clay or slag. Fly ash is also reported to strengthen some concrete mixes (Dodson and Roberts, 1980). According to Boral Material Technologies, Feb. 5, 2004, “Certain fly ashes retard concrete initial set times and this may prove to be advantageous during the hot weather.” A problem with using fly ash, however, is that there is no known accelerator that may be used with the fly ash mixture to decrease the time required for the mixture to set in cold weather, e.g. temperatures less than 60° F. A non-chloride type accelerator in a fly ash mixture may even retard the setting time of concrete.

In summer, fly ash is extensively used. Yet, there are many applications for which concrete must be poured at low temperature e.g. winter months, cold climates, high elevations. However, in winter, costs of making concrete go up because addition of fly ash is often not suitable because of slow setting.

A concrete mixture that reduces costs and accelerates setting of the concrete in cold temperatures is needed by the industry.

### SUMMARY OF THE DISCLOSURE

Methods and compositions for a concrete admixture allows use in low temperatures. A novel concrete admixture including a non-chloride accelerator, and a nitrite based corrosion inhibitor, accelerates the time required to set concrete in low temperature settings even when fly ash is a component. A suitable admixture includes a mixture of a non-chloride type accelerator and a calcium nitrite-based corrosion inhibitor. Sodium, potassium, magnesium and aluminum are alternatives to calcium. Other ingredients include hydraulic cement, e.g. Portland cement, aggregates, fillers and optional additives.

The components of the admixture can be combined and then added together to the other ingredients to make concrete, or they can be added separately. The admixture may be added to any concrete which is produced from cement, aggregates, optional additives, fillers and water.

Slump, which characterizes fluidity, shows that concrete mixes with the disclosed admixture sets faster than a concrete mix without the admixture.

Based upon tests disclosed herein, it has been found that the setting time of a concrete mix containing fly ash, is reduced by approximately 50-70% at an ambient temperature of about 60° F. or less, down to about 0° F., if the disclosed admixture is used. The admixture facilitates setting at low temperatures in all forms of concrete, with or without fly ash.

Uses include bridges, columns, docks, and highways and other applications for structural concrete.

Definitions

Accelerators=Admixtures that decrease the setting time of concrete by increasing the rate of hydration.
Admixture=A material other than water, aggregates, or cement that is used as an ingredient of concrete or mortar to control setting and early hardening, workability, or provide additional cementing properties.
Aggregate=Insert solid bodies such as crushed rock, sand, gravel.
Cement=Finely powered mixtures of inorganic compounds which when combined with water hardens with hydration.
Concrete=A hard compact building material formed when a mixture of cement, fine aggregates such as sand, coarse aggregates such as gravel, and water undergoes hydration.
Cure=To keep concrete moist during initial hardening.
Curing=In the concrete industry, “curing” refers to protecting the concrete with blankets or covers, fogging, spraying sealer on it, while it is in a plastic state.
Fly ash=“Fly ash” is a pozzolon—a silicious or aluminosilicious material that possesses little or no cementitious value but will, in the presence of water and in finely divided form, chemically react with the calcium hydroide released by the hydration of portland cement to form materials with cementitious properties. High calcium fly ash is cementitious. “Fly ash” is defined in ASTM C-618.
Hydraulic Cement=Cement which sets and hardens as result of chemical reactions between the water and the cement.
Limestone=Mineral rock of calcium carbonate.
MortarS=Cement paste with sand.
Pozzolan cement=Volcanic rock powdered and used in making hydraulic cement.
Portland cement=A hydraulic cement consisting predominantly of calcium silicates which reacts with water to form a hard mass.
Retardants=Admixtures that increase the setting time of concrete by slowing down hydration.
Set=Transformation of cement paste or concrete from a fluid-like consistency to a stiff mass.
Slump=Is a measure of relative consistency or plasticity of a wet concrete mix; wetness measures from about ¼ to 12 inches; e.g. 9 is very wet.
Slump test=Test used to determine workability.
Workability=How easily of manipulating the concrete admixture.

### DESCRIPTION OF THE DISCLOSURE

A novel concrete admixture includes a mixture of a non-chloride type accelerator and a nitrite-based corrosion inhibitor that work in combination to accelerate the setting time of a concrete mixture at low ambient temperatures e.g. less than 60° F. A suitable admixture contains about 30% accelerator and 70% corrosion inhibitor up to about 0° F. Acceleration occurs even with a 50%-50% admixture, but cost is higher because of the higher cost of the accelerator. Fly ash is a pozzolan used in cement mixtures. Use of the admixture reduces the time required for a cement and fly ash mixture to set by about 50-70%. Although non-chloride type accelerators such as POZZUTEC® 20 are known in the art of concrete making, they are not able to be used with fly ash because the acceleration time is unacceptably slow. According to the manufacturer, POZZUTEC® 20 is “a multi-component, non-chloride, water-reducing and accelerating admixture formulated to accelerate concrete setting time . . . across a wide range of ambient temperatures”.

Low temperature setting of a concrete mixture including mixtures containing fly ash, may be accelerated by adding an accelerator to the mixture wherein the accelerator is a mixture of a non-chloride type accelerator and a nitrite-based corrosion inhibitor. A suitable accelerator is a the non-chloride accelerator known as POZZUTEC® 20 which is available from Master Builders, Inc. of Cleveland, Ohio, and a corrosion inhibitor such as RHEOCRETE® CNI which is also available from Master Builders, Inc. of Cleveland, Ohio or DCI®S from Grace Construction Products. RHEOCRETE® CNI is a corrosion inhibitor that protects against salt damage. Although the ingredients disclosed can be blended together or put in the concrete separately, manufacturers of the individual components recommend they not come into contact with other admixtures prior to entering the concrete.

POZZUTEC® 20 is a non-chloride admixture reported by the manufacturer to accelerate concrete setting time “and increase early and ultimate strengths across a wide range of ambient temperatures (hot, mild, cold and sub-freezing).” However, this admixture tends to retard set time of concrete mixes that include fly ash. POZZUTEC® 20 is said not to be compatible with a polycarboxylate admixture such as that reported by Anderson et al. (2003).

According to the manufacturer: “In sub-freezing temperatures, the only admixture recommended for use with POZZUTEC® 20 . . . is RHEOBUILD® 1000.”

According to the manufacturer, RHEOCRETE® CNI is a calcium nitrite based admixture for steel reinforced concrete. One action of Rheocrete® CNI is to inhibit the potentially corrosive effects of chloride—bearing concrete—making ingredients and to accelerate concrete setting times. The manufacturer indicates that a retarding admixture such as POZZOLITH® “may be added to the concrete to offset the acceleration of effects of Rheocrete CNI admixture”. According to Anderson et al. (2003) “Retarders are commonly used to offset the accelerating effect of hot weather on the setting of concrete . . . ” (0152). There is no mention of low temperature settings.

DCI®S Corrosion Inhibitor produced by Grace Construction Products is functionally equivalent to RHEOCRETE® CNI for the low temperature admixtures disclosed herein. DCI®S contains a minimum of 30% calcium nitrite. According to the manufacturer, DCI® S “chemically inhibits the corrosion action of chlorides on reinforced steel and prestressed strands in concrete,” and “is formatted not to affect concrete setting times”. Further, “DCI® S should not come into contact with other admixtures prior to entering the concrete”. An accelerator or a retarder may need to be added. It is compatible with pozzolans.

Other chemically and functionally equivalent accelerators and corrosion inhibitors are suitable for use in admixtures for concrete provided they accelerate concrete set times at temperatures of 60° F. to 0° F., and satisfy other requirements for the application for which the concrete is produced. The disclosed methods and compositions to reduce set time of concrete are used in concrete mixes for which other components are suitable for a specified application e.g. strength, workability at low temperatures.

### EXAMPLES

### Example 1

### Comparing Concrete Setting Time Using Disclosed Admixture

To test the effects of an admixture of 30% POZZUTEC® 20 (“POZZ”) and 70% DCI/CNI on setting time of a concrete mixture that included fly ash, four boxes were prepared with poured concrete, and setting times were compared at low ambient temperatures (about 480-50°).

Box 1 had only POZZUTEC® 20.

Box 2 had only RHEOCRETE® CNI and calcium.

Box 3, had POZZUTEC® 20 and RHEOCRETE® CNI.

Box 4 had neither POZZUTEC® 20 nor RHEOCRETE® CNI.

No water reducing agent was used. Concrete was poured into the boxes. To determine whether a mix was set, the surface (top) of the poured concrete in each box was touched at about the same times periodically over a period of several hours to determine the first concrete to set. That was Box 3, contains the admixture of 30% POZZ and 70% CNI. (Table 1). Other suitable ways to test whether concrete is set include throwing a rock at the surface, and inferring if the rock rolls, that the concrete is set. A tamping rod can be used; needles can be inserted.

TABLE 1
HARD ROCK CONCRETE

| MATERIALS | 1 | 2 | 3 | 4 (standard) |
|---|---|---|---|---|
| Sand | 1350 | 1350 | 1350 | 1350 |
| Limestone | 1780 | 1780 | 1780 | 1780 |
| Cement | 470 | 470 | 470 | 470 |
| Fly ash | 100 | 100 | 100 | 100 |
| Air | 1.2 oz cwt | 1.2 oz cwt | 1.2 oz cwt | 1.0 oz cwt |
| POZZUTEC ®20 | 7.0 oz cwt | 0 | 7.0 oz cwt | 0 |
| DCI/CNI | 0 | 5.0 oz cwt | 15.0 oz cwt | 0 |
| Calcium | 0.5% | 0.5% | 0 | 0 |
| Water | 30.0 | 30.0 | 30.0 | 30.0 |
| | gallons | gallons | gallons | gallons |

### Example 2

### Confirming Improvement in Concrete Setting Using the Disclosed Admixture

The test was repeated twice and the results of both led to the same conclusion-that the 30%-70% composition of POZZUTEC®920 to RHEOCRETE® CNI or DCI® S had the shortest setting time.

In Table 2, other compositions are shown. The calcium in 2 did not affect the results. DCI® S was substituted for RHEOCRETE®. Boxes 1 and 2 set before box 3.

TABLE 2
HARD ROCK MIX CONCRETE

| MATERIALS | 1 | 2 | 3 |
|---|---|---|---|
| Sand | 1315 | 1315 | 1315 |
| Limestone | 1780 | 1780 | 1780 |
| Cement 1 | 470 | 470 | 470 |
| Fly ash | 100 | 100 | 100 |
| Water | 26 | 28 | 31 |
| POZZUTEC ®20 | 7.0 oz cwt | 7.0 oz cwt | 0 |
| Air | 1.45 oz cwt | 1.45 oz cwt | 1.5 oz cwt |
| Calcium | 0 | 0.5% | 0 |
| DCI | 15.0 oz cwt | 15.0 oz cwt | 0 |
| Retarder | 0 | 0 | 3.0 oz cwt |

Dosages of the components of the admixture—a non-chloride type accelerator and a nitrite based corrosion inhibitor, depend on ambient and concrete temperatures, cement chemistry, concrete mix preparations, the amount of set time acceleration needed and strength performance required. For example, see Table 3. Desired acceleration is a standard variable provided by the customer.

TABLE 3
SUITABLE DOSAGES FOR CONCRETE

| Desired Acceleration | POZZ-20 | CNI/DCI |
|---|---|---|
| .5% | 3 oz cwt | 5 oz cwt |
| 1% | 5 oz cwt | 10 oz cwt |
| 1.5% | 7 oz cwt | 15 oz cwt |
| 2% | 9 oz cwt | 18 oz cwt |
| 3% | 11 oz cwt | 22 oz cwt |

cwt = 100 weight

### Documents Cited

The following documents are incorporated by reference to the extent they relate to the practice of the disclosed methods and compositions.
1. U.S. Pat. No. 4,210,457 (Dodson and Roberts, 1980).
2. “Why should I use fly ash?” Boral Material Technologies, http: //www.concrete.com/documents/bora1article2.htm (Feb. 5, 2004)

1. A method of accelerating setting time of concrete at low temperatures, the method comprising:
(a) determining that a concrete mixture is to be poured at an ambient temperature of less than 60° F.:
(b) obtaining an admixture comprising a non-chloride type accelerator and a nitrite-based corrosion inhibitor; and
(c) adding the admixture to a cement either separately or jointly, to produce a concrete mix with an accelerated setting time compared to a concrete without the admixture.

2. The method of claim 1, wherein the admixture is added to the concrete when the ambient temperature is less than about 60° and more than 0° F.

3. The method of claim 1, wherein the admixture is comprised of about 30% of the non-chloride type accelerator and 70% parts of the nitrite-based corrosion inhibitor.

4. The method of claim 1, wherein the corrosion inhibitor is calcium nitrite-based.

5. The method of claim 4, wherein the corrosion inhibitor is RHEOCRETE® CNI.

6. The method of claim 1, wherein the non-chloride type accelerator is POZZUTEC® 20.

7. The method of claim 1, wherein the concrete contains at least one filler.

8. The method of claim 7, wherein the filler is a pozzolan.

9. The method of claim 8, wherein the pozzolan is fly ash.

10. An admixture for use in concrete at temperatures of less than 60° F., the admixture comprising a non-chloride type accelerator and a nitrite-based corrosion inhibitor.

11. The admixture of claim 10, wherein the admixture comprises about 30% of the non-chloride type accelerator and about 70% of the nitrite-based corrosion inhibitor.

12. The admixture of claim 10 further comprising a filler.

13. The admixture of claim 12, wherein the filler is a pozzolan.

14. The admixture of claim 13, wherein the pozzolan is fly ash.

15. A method of accelerating the setting time of a concrete mixture containing fly ash, the method comprising the steps of:
determining that a concrete mixture is to be poured at an ambient temperature of less than 50° F. and greater than 0° F.;
selecting a non-chloride type accelerator;
selecting a calcium nitrite-based corrosion inhibitor; and
adding said non-chloride type accelerator and said calcium nitrite-based corrosion inhibitor to said concrete mixture containing fly ash, wherein the amount of said non-chloride type accelerator and said calcium nitrite-based corrosion inhibitor are selected to reduce setting time of said concrete mixture.

16. The method of claim 15 wherein said non-chloride type accelerator is added to said concrete mixture in amounts ranging from 3 ounces of accelerator per hundred weight of concrete to 11 ounces of accelerator per hundred weight of concrete, and wherein said calcium nitrite-based corrosion inhibitor is added to said concrete mixture in amounts ranging from 5 ounces of inhibitor per hundred weight of concrete to 22 ounces of inhibitor per hundred weight of concrete.

17. The method of claim 15 wherein said non-chloride type accelerator and said calcium nitrite-based corrosion inhibitor are added to said concrete mixture in proportion to each other of about 30% to 50% non-chloride type accelerator and about 50% to 70% calcium nitrite-based corrosion inhibitor.

18. The method of claim 17 wherein said non-chloride type accelerator and said calcium nitrite-based corrosion inhibitor are combined together before adding to said concrete mixture.
